(19) United States
(12) Patent Application Publication
(10) Pub. No.: US 2003/0117018 A1
(43) Pub. Date: Jun. 26, 2003

(54) Current mirror seatbelt interface circuit

(76) Inventor: James M. Young, Brighton, MI (US)

Correspondence Address: Jacques M. Dulin, Esq., Innovation Law Group, Ltd., Suite 24, 271 S 7th Avenue, Sequim, WA, 98382-3652, US

(21) Appl. No.: 10/027,042

(22) Filed: Dec. 21, 2001

(51) Int. Cl. H02G 3/00

(52) U.S. Cl. 307/10.1

(57) ABSTRACT

A current mirror seatbelt interface circuit and method for accurately determining seatbelt latch status in a passenger vehicle safety system. By the use of a current mirror circuit, the current through the seatbelt latches can be accurately determined. This determination is used to activate (if the seatbelts are buckled) or inactivate (if the seatbelts are unbuckled) the safety protection systems including passenger airbags and seatbelt tensioners. The current through the seatbelt latch sensor is mirrored through the circuit herein disclosed. The mirrored current is monitored and the current value is analyzed by an airbag control microprocessor circuit to activate or inactivate the safety system. Parallel wired matching transistors in conjunction with a control transistor accurately provide the mirrored current information to the microprocessor. In addition, multiple seatbelt latch sensors can be connected to the current mirror by adding control transistors for each additional seatbelt latch.

### CROSS REFERENCE TO RELATED APPLICATION

This application is related to U.S. Ser. No. 09/841,916, filed on Apr. 23, 2001, entitled “Seatbelt Tensioner Firing Loop”, by James M. Young, and similarly assigned to Robert Bosch Corporation. This co-pending application is herein incorporated by reference to the extent needed to provide additional disclosure of vehicle occupant safety systems, namely seatbelt tensioner firing loops, and the benefit of the filing date for such disclosure is hereby claimed under 35 USC §120.

### TECHNICAL FIELD

This invention relates to vehicle seatbelt latch sensor circuits, and more particularly to a current mirror seatbelt interface circuit in a vehicle electronic control module for determining the occupant seatbelt latch status. The inventive circuit can be integrated in an airbag control system or seatbelt tensioner system.

### BACKGROUND

Vehicle passenger safety systems include airbags, seatbelts, and occupancy sensor systems that provide “state” information to airbag and seatbelt control systems. In the case of an automobile, the automotive occupancy systems (AOS) may include one or more types of sensors to determine the nature and position of occupants, outputting one or more signals to airbag and/or seatbelt deployment tensioner control devices. These form so-called “smart airbag” systems, in which the deployment of one or more types of airbags, e.g., front, side, curtain, or the like, airbags, is controlled. Examples of control schemes for airbags include: staged fill, slower fill, partial fill to provide “softer” cushioning; sequential or differential fill of different airbags (e.g., side or head curtains before frontal); and the like.

Seat, lap, and chest belts (herein body restraints) also form a first line of safety and are integral to passenger protection. In many instances, airbags do not or should not deploy in certain types of low speed crashes. These body restraints provide protection in such crashes. However, these restraint belts, by their nature, are user friendly to accommodate the variability of passenger size and girth, seasonal clothing variations, passenger comfort, and the like. Thus, in normal use, the belts may be latched, but loose, which condition can permit the user to move a considerable distance during a crash before being restrained. The whiplash effect of suddenly being restrained by “reaching the end of the leash”, so to speak, could conceivably itself contribute an injury, or permit injury to occur before the restraint slack is taken up. Accordingly, current practice is to provide seatbelts with appropriately sized squibs which fire upon signal from the ACM (airbag control module), to reel in the excess slack of the seatbelt, thereby reducing belt injury and making the retention more effective. A squib is a small electric or pyrotechnic device used to ignite a charge. The ACM signal may be internal or external sensor derived, or may be a signal derived from an accelerometer.

Neither the seatbelt tensioner squib system nor the airbag(s) should, however, fire unless the seatbelt is properly latched, preferably in place on a passenger. Vehicle electronic control modules are required to determine the status of occupant seatbelt usage. This information can be used to warn the vehicle operator and modify airbag inflation profiles. It is important that the seatbelt latch status be accurately determined. Seatbelt latch sensors typically include current source sensors or resistive load sensors. The current through the sensor or resistance of the sensor changes with the state of the latch.

### THE INVENTION

### SUMMARY, INCLUDING OBJECTS AND ADVANTAGES

The present invention relates to a current mirror seatbelt interface circuit and method for accurately determining the seatbelt latch status in a passenger vehicle safety system. One embodiment includes a current mirror circuit having first and second current paths with a seatbelt latch sensor circuit in the second current path, and a current sensing circuit in the first current path. The first current in the first current path mirrors the current in the second current path. A control microprocessor circuit is responsive to the current in the first current path for controlling the activation of a passenger safety system. The current mirror circuit includes first and second matching transistors, the first transistor being included in the first current path and the second transistor being included in the second current path. The interface circuit further includes a control transistor coupled between the second matching transistor and the seatbelt latch sensor for controlling the current to the seatbelt latch sensor circuit in response to a signal from the control microprocessor circuit.

In an important alternative embodiment, the invention may have one or more additional seatbelt sensor circuits in parallel connection to the first seatbelt latch sensor circuit, and this embodiment includes a second control transistor coupled between the second matching transistor and the second seatbelt latch sensor circuit for controlling the current through the second seatbelt latch sensor circuit in response to a signal from the control microprocessor circuit. In this embodiment, several seatbelt latch sensor circuits can be measured with one current mirror circuit. The microprocessor selects the seatbelt latch circuit to measure by activating the corresponding control transistor. That is, the microprocessor can be programmed to selectively monitor individual seat latch circuits, e.g., the microprocessor activates the control transistors one by one to multiplex through multiple seatbelt latch sensors. The current through the first current path is detected by the control microprocessor circuit in discrete values, the discrete values indicating that the selected seatbelt is latched or not. Additional discrete values signal and thereby detect open circuits (no current flow) and short circuit (high current flow).

A further embodiment includes a method of monitoring the status of passenger vehicle seatbelt latches and includes providing a current mirror circuit with first and second current paths and controlling the current flow in the second current path by a control microprocessor circuit. The status of the seatbelt latches are monitored by providing a seatbelt latch sensor circuit. Further, the current is measured in the first current path, the current in the first current path monitoring the current flow in the second current path, and applying the measured current to the control microprocessor circuit to provide the status of the seatbelt latches to the microprocessor circuit. An output path is provided from the microprocessor circuit to a vehicle airbag system and/or a vehicle seatbelt tensioner system to fire or not too fire depending on the status of the seatbelt latches in the event of a detected collision or sudden deceleration. The measuring step further includes detecting that the measured current indicates the state of each selected seatbelt. Current proportioning can be employed to determine which and the number of seatbelts are latched (or not).

### BRIEF DESCRIPTION OF THE DRAWINGS

For a more complete understanding of the embodiments of the invention herein, reference may be had to the following detailed description in conjunction with the drawings wherein:

FIG. 1 is a schematic diagram of a typical prior art solution to seatbelt squib firing systems; and

FIG. 2 is a schematic diagram of a current mirror seatbelt interface circuit in accordance with the present invention.

Reference numbers refer to the same or equivalent parts of the present invention throughout the various figures of the drawings.

### DETAILED DESCRIPTION, INCLUDING THE BEST MODE OF CARRYING OUT THE INVENTION

The following detailed description illustrates the invention by way of example, not by way of limitation of the principles of the invention. This description will clearly enable one skilled in the art to make and use the invention, and describes several embodiments, adaptations, variations, alternatives and uses of the invention, including what is presently believed to be the best modes of carrying out the invention.

In this regard, the invention is illustrated in the several figures, and is of sufficient complexity that the many parts, interrelationships, and sub-combinations thereof simply cannot be fully illustrated in a single patent-type drawing. For clarity and conciseness, several of the drawings show in schematic, or omit, parts that are not essential in that drawing to a description of a particular feature, aspect or principle of the invention being disclosed. Thus, the best mode embodiment of one feature may be shown in one drawing, and the best mode of another feature will be called out in another drawing.

All publications, patents, and applications cited in this specification are herein incorporated by reference as if each individual publication, patent, or application had been expressly stated to be incorporated by reference.

This invention relates to vehicle seatbelt control systems and circuits for determining the state of seatbelt latching to prevent the tensioner squib(s) or the vehicle airbag(s) from firing unless the seatbelt latch is engaged, normally about a passenger. Specifically, the invention is a current mirror seatbelt interface circuit for accurately determining the seatbelt latch status in passenger vehicles.

Vehicles manufactured and sold in the United States since the mid 1980s are required to provide front seat airbags that are activated when the vehicle experiences a collision. One problem initially encountered was that an airbag for a given seat would be activated in a collision whether or not a vehicle occupant occupied the seat. Similarly, a seatbelt tensioner system could, as well, be activated needlessly if no passenger was in the particular seating area of the vehicle. If the seat was not occupied when the corresponding airbag and/or seatbelt tensioner were activated, the system would activate, the result being economic waste with possible injury to one or more other vehicle occupants. There are known devices that deactivate an airbag or seatbelt tensioner activator if the seat is unoccupied or if the corresponding seatbelt is unlatched. However, many of these devices require complex electrical circuitry or require relatively large amounts of electrical power, through current leakage, in order to function properly.

A seatbelt tensioner firing loop, similarly engaged in vehicle occupant safety systems, is disclosed in U.S. Ser. No. 09/841,916, filed on Apr. 23, 2001, “Seatbelt Tensioner Firing Loop”, by James M. Young, and similarly assigned to Robert Bosch Corporation. This co-pending application is herein incorporated by reference for additional background and understanding of the context of this invention.

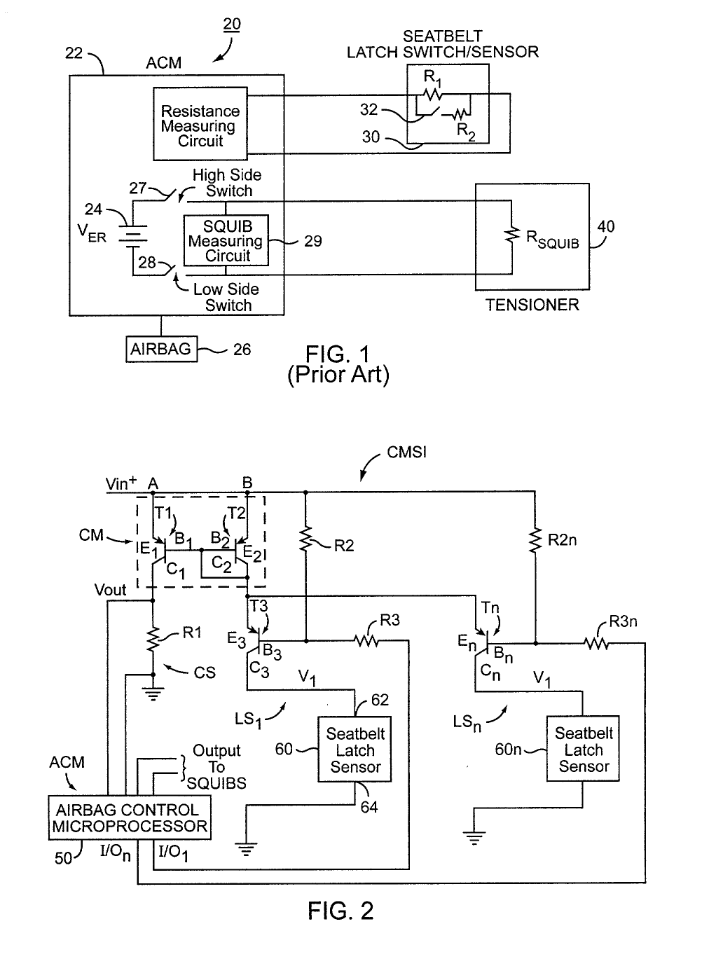

FIG. 1 discloses a seatbelt tensioning circuit typical of currently available commercial production airbag modules, e.g., Bosch AB 8.7 Airbag Control Module P/N 0 285 001 344 manufactured and sold by Robert Bosch Corporation. Airbag control system 20 includes an airbag control module 22, one or more seatbelt latch switches 30, and one or more ACM airbag deployment loop 26 and seatbelt tensioner squib loops 40, typically connected to the vehicle's power system. The airbag control module 22, seatbelt latch 30, airbag loop 26, and tension squib loop 40 are conventional equipment typically found in modem automobiles and other vehicles, such as trucks and buses, and are well known in the prior art.

The seatbelt latch switch module 30 includes a latch switch 32. The seatbelt switch 32 could be a separate switch that would be activated when the seatbelt is coupled together as when placed around a passenger. Conventional seatbelt latch switches are available commercially from a variety of suppliers, such as Takata, Cherry Automotive, and Autoliv. Alternatively, but not preferred, the seatbelt latch switch 32 comprises the actual metal ends of the seatbelt itself which, when coupled together, electrically close the seatbelt latch switch through electrical wires in each half of the belts themselves. That is, the metal ends of the seatbelts could comprise the poles or contacts of a switch which, when coupled together, close and complete a circuit which is detected by the airbag control module as the switch being closed, i.e., fastened around a passenger.

The seatbelt tensioner squib 40 is a standard firing squib which, when fired in an accident or a crash, or as a result of a sudden deceleration, immediately causes the seatbelt to rewind with a result of an increase in tension across a passenger's body. This immediately eliminates the slack in the seatbelt system so that the seatbelt can restrain a passenger's movement quickly and effectively, preventing potentially dangerous body movement. In a collision, or other rapid deceleration, a sensor (not shown) in the airbag control module detects the rapid deceleration and, if the seatbelt buckle switch 32 is closed, or the seatbelt latch members are connected, denoting a passenger at that seat position, the airbag control module 22 sends a firing signal to the seatbelt tensioner squib 40 which causes the squib to fire, i.e., energize. This firing causes the seatbelt, which may not have been adequately tight about the passenger, to immediately tighten and draw shorter about the passenger. This increased tension prohibits or at least vastly reduces the forward motion of the passenger who is undergoing rapid deceleration due to the incurring collision. While the seatbelt squib 40 is firing, the airbag 26 may also deploy, thereby adding further safety protection to the passenger. High-side switch 27 and low-side switch 28 isolate the voltage supply 24 V_{ER} from the squib current.

The inventive Current Mirror Seatbelt Interface circuit (CMSI) in FIG. 2 includes a paired-transistor current mirror circuit in association with seatbelt latch sensor circuits and an electronic processor control module for a collision occupant protective system such as an airbag system or seatbelt tensioner system. The CMSI provides a circuit that reliably interfaces to both current source type and resistive load type seatbelt latch sensors and switches. The objectives of this invention are to provide a cost-effective, reliable method of determining the seatbelt latch status; to interface to both current source and resistive type seatbelt latch sensor circuits; to operate with a low input voltage; and to provide an interface for multiple seatbelt latches.

The preferred embodiment of the Current Mirror Seatbelt Interface Circuit CMSI of the invention is shown in FIG. 2. The CMSI includes current mirror circuit CM, a current sensing circuit CS, one or more seatbelt latch sensor circuits LS1-LSn, and a suitable microprocessor, such as an airbag control microprocessor 50 and its associated circuit board, referred to as electronic control module or ECM.

The current mirror CM functions to both (a) supply current to the seatbelt latch sensor circuits 60 and 60n, and (b) provide for current measurement. A pair of PNP transistors T1 and T2 are connected as a current mirror CM (outlined in dashed lines in FIG. 2), and it is preferred that transistor T1 and transistor T2 be matched transistors. In current mirror CM, the emitters E1 and E2 of transistors T1 and T2, respectively, are each connected to the input voltage Vin as shown. The bases B1 and B2 of each matched transistor T1 and T2 are connected to the collector C2 of transistor T2. In the current mirror CM, there is a substantially equal current flowing in the collectors C1 and C2 of each of transistors T1 and T2.

Transistor T1 is the current sensing side of the current mirror CM. The collector C1 of transistor T1 is connected to a current sensing circuit CS that is used to determine the current flow in the current mirror CM.

Transistor T2 is the controlling side of the current mirror CM. The collector C2 of transistor T2 is connected to one or more seatbelt latch circuits (of which two are shown in FIG. 1), designated as LS1-LSn, which are described further below. The output on collector C2 of transistor T2 drives the latch sensor circuits, which are connected in parallel to ground.

The current sensing circuit CS comprises a current sense resistor R1 connected in series between the collector C1 of transistor T1 and ground. The current that flows through the seatbelt latch sensor 60 is mirrored by transistor T1 onto resistor R1. The output voltage is read across resistor R1. The resulting voltage Vout is proportional to the current flowing through the seatbelt latch sensor. Resistor R1 is selected so that the maximum current expected through the seatbelt latch sensor or sensors gives a full scale reading. Typical Hall Effect seatbelt sensors operate between 0 mA and 20 mA. Thus, a value of 200 Ohms for R1 gives a full scale output of 4.0V. This allows a typical microprocessor A/D converter (operating in the range of 0V to 5V) to safely read the inventive circuit output voltage. This also permits an additional measurement range for short circuit detection where the output voltage would exceed 4.0V.

The output voltage Vout is read by a suitable microprocessor analog input port. The value of the seatbelt sensor current Isbs can then be determined by an algorithm, in which the microprocessor is programmed to calculate the current flowing through the seatbelt sensor by applying Ohm's law, i.e.: Isbs=Vout/R1. The current flowing through the seatbelt latches can then be used to determine the state of the seatbelt latch, e.g., no current=unlatched (seatbelt not buckled).

In the unbuckled state, the microprocessor, such as the airbag control microprocessor ACM of FIG. 2, may respond to the state determination by such actions as triggering a warning lamp or an audible signal, modifying the airbag system deployment profile, and/or disabling the firing of seatbelt tensioners, and the like. In the buckled state, the microprocessor ACM may respond to the state determination by such actions as disabling a warning lamp or audible signal, modifying the airbag system deployment profile, and/or enabling firing of seatbelt tensioners, and the like. Default actions can be programmed to be carried out if the microprocessor determines that the measurement is invalid or indeterminate of seatbelt state.

If there is more than one seatbelt latch sensor connected in parallel to the current mirror, as shown in FIG. 2, the measured current Isbs is calculated individually for each sensor. Alternatively, a separate CMSI circuit may be used for each belt latch. The microprocessor polls the control transistors T3 through Tn by activating them one at a time to multiplex through multiple seatbelt latch sensors to determine the state of each and, ultimately all of them, in a multiple seatbelt-equipped vehicle.

Each seatbelt latch sensor circuit LS1 comprises a control transistor T3 with the emitter E3 connected to the collector C2 of transistor T2. The collector C3 of transistor T3 is connected to the positive terminal 62 of the seatbelt latch sensor 60. The negative terminal 64 of the seatbelt latch sensor 60 is connected to ground. Transistor T3 is used as a switch to control the current to the seatbelt latch sensor 60. A suitable microprocessor I/O port I/O1 controls transistor T3, the I/O port being connected to the base B3 of transistor T3 through resistor R3.

The seatbelt latch sensor circuit LS1 is turned on by setting the microprocessor port I/O1 to low (i.e., ground) voltage. Resistors R2 and R3 are chosen such that transistor T3 is saturated 10 in this state. This allows current to flow through the seatbelt latch sensor circuit LS1. The additional parallel seatbelt latch sensor circuit LSn operates in the same matter, being controlled by microprocessor port I/On.

An additional resistor R2 is connected at one of its terminals to Vin and is connected at the other of its terminals between resistor R3 and the gate B3 of transistor T3. Resistor R2 keeps transistor T3 off (non-conducting) if the microprocessor port I/O1 is set to a high impedence state during reset, by maintaining a sufficient voltage at gate B3 to maintain transistor T3 in an off state when the port I/O1 is off (open circuit).

The current mirror seatbelt interface circuit of the invention has the following advantages over the prior art:

1. There is a reduced voltage input;

2. It allows entire dynamic range of microprocessor analog input to be used;

3. It interfaces to (can use) both current source and resistor type sensors;

4. It has a reduced number of components; and

5. It permits a single wire interface from the sensor to the module.

The current mirror circuit CM allows the voltage Vin to be as low as a diode voltage drop and a transistor saturation voltage above the minimum operating voltage of the type seatbelt latch sensor employed (e.g., resistive or current source). The diode drop is the Veb of T1 and the saturation voltage is Vce of T3, . . . Tn. In the embodiment where a resistive seatbelt latch circuit sensor is used, the input voltage Vin should be regulated. This eliminates the need to include the input voltage in the calculations. In the embodiment where a current source seatbelt latch sensor 60 is used, the input voltage need not be regulated. Additional transistor/resistor networks, as shown in FIG. 1, can be provided to accommodate additional seatbelt latch sensors.

One example of the seatbelt sensor circuit, L1-Ln, employs a Hall Effect type switch, in which the open/closed signal of the latch switch is regulated by the corresponding near proximity or distant state of a magnetic element. The Hall element and magnetic element are mounted in the latch/buckle assembly so that, for example, buckling the seatbelt brings the Hall sensor close to the magnetic element, and turns the switch “on”. Unbuckling removes these elements from close proximity, and turns the switch off. This permits an environmentally sealed switch not prone to inadvertent short-circuiting.

Further, by biasing the voltage at positive terminal V1 of the seatbelt latch sensor to a non-zero voltage, typical vehicle wiring faults can be diagnosed such as shorts to ground or vehicle battery. An additional analog input port is provided to read the voltage at V1 to form these diagnostics.

Alternate embodiments of the CMSI of the invention may be made by one of ordinary skill in the art employing NPN transistors or corresponding JFET or MOSFET technology, and these alternative environments may be used to interface with any current source or resistor vehicle sensor.

### Industrial Applicability

It is clear that the inventive current mirror seatbelt interface circuit has wide applicability for use in a wide range of vehicles, as it can be employed by itself as such, or in combination with airbag control modules.

The inventive system has been described with reference to a single passenger seat and single seat airbag and seat tensioner system. However, the invention also has applicability to multiple passenger seats, whether the seat airbags and tensioners act independently, as with independent or bucket seats; or in concert, as with dual seat, such as in a bus or the back seat of an automobile.

While embodiments and applications of this invention have been shown and described, it will be apparent to those skilled in the art having the benefit of this disclosure that many equivalents and other modifications are possible without departing from the inventive concepts herein. The invention, therefore, is not to be restricted except in the spirit of the appended claims, by reference to the specification as need be.

1. A passenger safety interface circuit comprising:
a current mirror circuit having first and second current paths,
a seatbelt latch sensor circuit in said second current path,
a current sensing circuit in said first current path, said first current in said first current path mirroring the current in said second current path, and
a control microprocessor circuit responsive to the current in said first current path for controlling the activation of a passenger safety system.

2. The passenger safety interface circuit as set forth in claim 1 wherein said current mirror circuit includes first and second matching transistors, said first transistor included in said first current path and said second transistor included in said second current path.

3. The passenger safety interface circuit as set forth in claim 2 further including a control transistor coupled between said second matching transistor and said seatbelt latch sensor for controlling the current to said seatbelt latch sensor circuit in response to a signal from said control microprocessor circuit.

4. The passenger safety interface circuit as set forth in claim 3 further including a first current sense resistor in said first current path between the first matching transistor and ground potential, the voltage across said resistor being proportional to the current through said seatbelt latch sensor circuit and providing the input signal to the control microprocessor circuit.

5. The passenger safety interface circuit as set forth in claim 4 wherein said control microprocessor circuit includes outputs to control the operation of a vehicle airbag system and/or a vehicle seatbelt tensioner system.

6. The passenger safety interface circuit as set forth in claim 5 further including at least a second seatbelt sensor circuit in parallel connection to said first mentioned seatbelt latch sensor circuit, and
at least a second control transistor coupled between said second matching transistor and said second seatbelt latch sensor circuit for controlling the current through said second seatbelt latch sensor circuit in response to a signal from said control microprocessor circuit.

7. The passenger safety interface circuit as set forth in claim 6 wherein the current in said first current path mirrors the current in the second current path, said second current path including the current in said first seatbelt latch sensor circuit and at least said second seatbelt latch sensor circuit.

8. The passenger safety interface circuit as set forth in claim 7 wherein the current through said first current path is detected by said control microprocessor circuit in discrete values, said discrete values indicating that neither seatbelt is latched, only said first seatbelt is latched, only a second seatbelt is latched, or that both seatbelts are latched.

9. A method of monitoring the status of passenger vehicle seatbelt latches comprising:
providing a current mirror circuit with first and second current paths,
controlling the current flow in said second current path by a control microprocessor circuit,
monitoring the status of the seatbelt latches by providing a seatbelt latch sensor circuit,
measuring the current in said first current path, said current in said first current path mirroring the current flow in said second current path,
applying the measured current to the control microprocessor circuit to provide the status of the seatbelt latches to the microprocessor circuit, and
providing an output path from said microprocessor circuit to a vehicle airbag system and/or a vehicle seatbelt tensioner system to fire or not to fire depending on the status of the seatbelt latches in the event of a detected collision or sudden deceleration.

10. A method of monitoring the status of passenger seatbelt latches comprising:
providing a current mirror circuit with first and second current paths, said passenger seatbelt latches being included in the second current path,
mirroring the current in said second current path in said first current path,
measuring the current in said first current path,
applying the measured current to a control microprocessor circuit, and
controlling the activation of a vehicle airbag system and/or a vehicle seatbelt tensioner system to enable or disable firing depending on the status of the seatbelt latches in the event of a detected collision or sudden deceleration.

11. The method as set forth in claim 10 further including the step of:
providing at least a second passenger seatbelt latch connected in parallel in said second current path; and wherein:
said step of measuring the current in said first current path includes activating the corresponding control transistor to allow current flow through the selected seatbelt latch sensor.
